(19) United States
(12) Patent Application Publication
(10) Pub. No.: US 2013/0086841 A1
(43) Pub. Date: Apr. 11, 2013

(54) Overhead Door Object Detection Apparatus

(71) Applicants: William M. Luper, Clovis, CA (US); Mark Hansston, Clovis, CA (US)

(72) Inventors: William M. Luper, Clovis, CA (US); Mark Hansston, Clovis, CA (US)

(21) Appl. No.: 13/647,386

(22) Filed: Oct. 9, 2012

Related U.S. Application Data
(60) Provisional application No. 61/545,534, filed on Oct. 10, 2011.

(51) Int. Cl. E05F 15/00

(52) U.S. Cl. CPC E05F 15/0026
USPC 49/28

(57) ABSTRACT

An overhead door object detection apparatus that is configured to be utilized with a retractable garage door leading into a garage to determine if there is an object in the downward path of the garage door and, if there is an object, to stop the downward movement of the garage door before it hits the object and reverse to an upward movement. The apparatus generally comprises a transmitter unit that is attached to the leading edge of the garage door to detect the object and a receiver unit that controls the movement of the garage door. The transmitter unit comprises a proximity sensor, a microprocessor, a tilt switch and a transmission source to transmit an object detection signal to the receiver unit. The receiver unit has a receiving device, a microprocessor and a door reversing mechanism that engages the door's standard safety reversing sensor.

### CROSS-REFERENCE TO RELATED APPLICATIONS

This patent application claims priority to U.S. Provisional Application No. 61/545,534 filed Oct. 10, 2011.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to apparatuses and systems configured to prevent the downward directed leading edge of a retractable garage door from hitting or otherwise contacting an object in its path as it moves to close the garage door opening. More particularly, the present invention relates to such apparatuses and systems that utilize a transmitter unit attached to or near the leading edge of the door to direct a proximity sensor downward from the transmitter unit to detect an object in the garage door's path. Even more particularly, the present invention relates to such apparatuses and systems that detect a light pulse or other signal from the transmitter to reverse the direction of the garage door and avoid contacting the object in the garage door's path.

B. Background

Many homes, businesses, offices and other structures have garages in which a car, truck or other vehicle can be parked and/or a variety of items can be placed to store those items. Most such garages have a garage door opening that is selectively closed by a retractable garage door that moves to substantially fill the entire space defined by the garage door opening. Although some garage doors pivot to open and close, most garage doors are configured to be retractable such that they move upward and downward to open or close the garage door opening. The typical garage door is moveably mounted along its sides in a track or rail system that is attached to the sides of the garage door opening and is configured such that the downward directed leading edge of the garage door contacts the floor of the garage when the garage door is in its fully closed position. In its opened position, the leading edge of the garage door is in spaced apart relation to the floor of the garage such that a vehicle can move under the garage door into and out of the garage. The typical garage door system has a drive mechanism, typically with a motor connected to a chain or cable drive system, that moves the garage door between its open and closed positions and one or more operating units that are utilized to selectively move the door between its open and closed positions. In a standard configuration, at least one of the operating units is fixedly mounted to a wall inside the garage, often near an access door associated with the garage, and an operating unit is located in or otherwise associated with one or more vehicles that move in and out of the garage.

One of the major problems with early retractable garage door systems was the fact that a person or object in the downward path of the garage door as it moved to its closed position could be contacted by the leading edge of the garage door. The person or object, including a pet, vehicle or an item from the garage, that was hit by the garage door could be killed, seriously injured or damaged by the contact with the garage door. This was particularly true if the length of the vehicle was only slightly less than the interior length of the garage, such that if a person did not park his or her vehicle far enough inside the garage the leading edge or other area of the garage door would strike the vehicle and, usually, cause damage to the vehicle and/or the garage door. To reduce the likelihood of damage, injury or death, garage doors have been required for many years to include one or more safety systems that cause the garage door to automatically reverse upon any level of contact with a person or item in the garage door path.

The typical garage door safety system comprises a sensor associated with either the garage door or the garage door opening, a reversible switching device associated with the motor to immediately reverse the operation thereof and a transmitting mechanism that transmits a signal to the reversible switching device. The sensor is configured to detect an object below the leading edge of the garage door, the transmitting mechanism is configured to send a reverse signal to the switching device and the switching device is configured to reverse the direction of the motor, which immediately begins moving the garage door upward to its open position. In an alternative configuration, the safety system is configured such that the transmitting mechanism sends a signal to a motor stopping device which stops the downward movement of the garage door, as opposed to reversing, as soon as an object is identified as being in the garage door path. In one configuration, the sensor is a sensitive contact sensor that is positioned along the leading edge of the garage door to sense any contact between the garage door and an object in the garage door opening. As soon as contact is made, the garage door stops moving downward and, typically, reverses direction. Another configuration for garage door safety systems is to utilize an infrared transmitter at one side of the garage door opening and an infrared receiver straight across at the other side of the garage door opening such that a beam of light is transmitted across the opening. If a person or object breaks the beam of light during the downward movement of the garage door, the garage door stops moving and, typically, reverses direction. These and other similarly configured garage door safety systems operate without any input required from the operator, such that the detection, stopping and/or reversing happens automatically.

With regard to damage to cars, trucks and other vehicles caused by contact between the downward moving garage door and the vehicle, this damage is typically caused by the operator of the vehicle not sufficiently pulling the vehicle far enough into the garage. If he or she fails to position the vehicle in the garage beyond the downward path of the garage door, a portion of the garage door (often the leading edge thereof) will contact the vehicle. Unfortunately, the contact type of garage door sensors may not prevent such damage because by the time any contact is identified by the sensor, the damage has already occurred. The infrared beam type of sensors can fail because the beam is typically positioned relatively low along the garage door opening, where it can best determine the presence of a small child or a pet in the garage opening, and the shape of the vehicle may be such that the portion of the vehicle extending into the garage door path does not break the beam of light and, as a result, does not set off the sensor. Although people utilize many apparatuses and devices to ensure their vehicle is pulled far enough into the garage to be out of the way of the downward moving garage door, including hanging items that contact the vehicle, markers on the floor or wall and electronic proximity switches in an attempt to identify a proper parking position, contact between the leading edge of a downward moving garage door and a vehicle in its path is still a relatively common occurrence.

What is needed, therefore, is an improved apparatus for determining if a person, vehicle or other object is in the downward path of the leading edge of a retractable garage door as it moves downward to its closed position so the garage door can be stopped and/or reversed so as to prevent any contact with the object. Such an improved apparatus should be configured to determine the presence of an object in the path of the downward moving garage door prior to making any contact with the object and independent of the shape or configuration of the object. As such, the improved apparatus should not utilize a sensor that relies on contact with an object or the interference with a beam of light across the garage door opening to determine the presence of an object in the path of the garage door. The improved apparatus should also be configured to detect all types of objects in the garage door path without mistaking the garage floor as an object that causes the garage door to stop and/or reverse direction.

### SUMMARY OF THE INVENTION

The overhead door object detection apparatus of the present invention provides the benefits and solves the problems identified above. That is to say, the present invention discloses an improved safety apparatus for use with retractable garage doors that is utilized to prevent contact with, and therefore harm or damage to, an object that is in the downward path of the garage door as it moves to its closed position. In a preferred configuration, the apparatus of the present invention is located at or near the leading edge of a retractable garage door and configured to determine the presence of an object in the path of the garage door as the door moves downward to its closed position so the garage door can be stopped and/or reversed prior to causing harm or damage to the object. The apparatus of the present invention determines the presence of an object in the downward path of the garage door prior to making any contact with the object and independent of the shape or configuration of the object so it will not cause damage before the garage door can be stopped and/or reversed or be “fooled” by the shape of the object. To accomplish the above, the improved safety apparatus of the present invention does not utilize a sensor that relies on contact with an object in the downward path of the garage door or interference with a beam of light across the garage door opening to determine the presence of the object. In its preferred configuration, the object detecting apparatus of the present invention is configured to detect all types of objects in the garage door path without mistaking the garage floor as an object that causes the garage door to inadvertently stop and/or reverse direction. The object detecting apparatus of the present invention can be included with new garage door installations or be provided as a retrofit for existing garage door systems.

In one general aspect of the present invention, the overhead door object detection apparatus comprises

[symbol]

Accordingly, the primary objective of the present invention is to provide an overhead door object detection apparatus that provides the advantages discussed above and elsewhere in the present disclosure and which overcomes the various disadvantages and limitations associated with presently available apparatuses for determining if an object is in the path of a downward moving overhead door.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is an outwardly looking perspective view of a garage through the garage door opening showing an overhead door object detection apparatus that is configured according to one embodiment of the present invention associated with a garage door in or near its open position;

FIG. 2 is the same view as FIG. 1 except with the garage door shown moving downward and an object in the downward path of the garage door;

FIG. 3 is the same view as FIG. 1 except the garage door is shown substantially in its closed position with the leading edge of the garage door shown near the garage floor;

FIG. 4 is a schematic showing the transmitter unit of the apparatus of the present invention;

FIG. 5 is a schematic showing the receiver unit of the apparatus of the present invention;

FIG. 6 is an alternative configuration wherein the transmitter unit sends a signal directly to the motor after detecting an object in the path of the garage door;

FIG. 7 is a second alternative configuration wherein the transmitter unit detects the light beam from the safety reversing mechanism to deactivate the apparatus; and

FIG. 8 is a third alternative configuration wherein the transmitter unit is deactivated when a presettable timer is activated.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures are illustrative of several potential preferred embodiments and, therefore, are included to represent several different ways of configuring the present invention. Although specific components, materials, configurations and uses are illustrated, it should be understood that a number of variations to the components and to the configuration of those components described herein and shown in the accompanying figures can be made without changing the scope and function of the invention set forth herein. For instance, although the description and figures included herewith generally describe and show use of the apparatus with a typical garage and to avoid contact with vehicles that are parked in the garage or items that are stored in the garage, those skilled in the art will readily appreciate that the present invention is not so limited. For instance, the apparatus can be utilized with storage units, office parking buildings or other structures that utilize a retractable overhead door to close an opening into the structure.

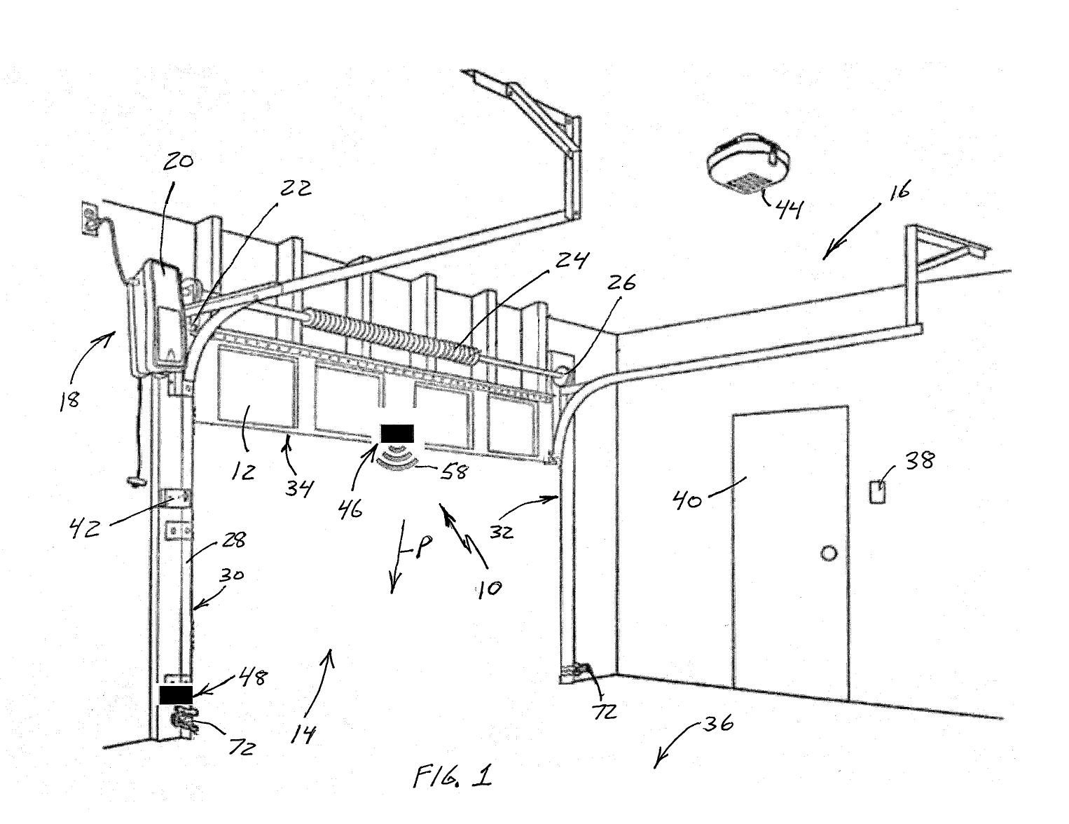

An object detection apparatus that is configured pursuant to one embodiment of the present invention is shown generally as 10 in the figures. The apparatus 10 of the present invention is particularly configured to be utilized with retractable overhead doors 12 that move up and down to open or close an opening 14 into an enclosure, such as a garage 16. In addition to the garage door 12, a typical garage door system 18 has a motor unit 20 operatively connected to a cable tension monitor 22, torsion spring 24 and drum 26 to allow the garage door 12 to controllably move upward and downward along a track or rail 28 along the sides 30 and 32 of the garage door opening 14 and above the garage 16, as best shown in FIG. 1. In the normal use of the garage door 12, the garage door system 18 is configured to move the garage door 12 downward along a garage door path, shown as P in FIG. 1, until the first or leading edge 34 of the garage door 12 is against the floor 36 of the garage 16. The typical garage door system 18 also comprises a wall-mounted control unit 38, usually at or near an access door 40 that provides an additional point of entry or exit for the garage 16, and a power door lock 42 at or near one of the sides 30/32 of the garage door opening 14, as shown in FIGS. 1 through 3. As is well known, most garages 16 also have a remote light 44 that is associated with the garage door system 18 such that it lights up upon the opening, and often the closing, of the garage door 12.

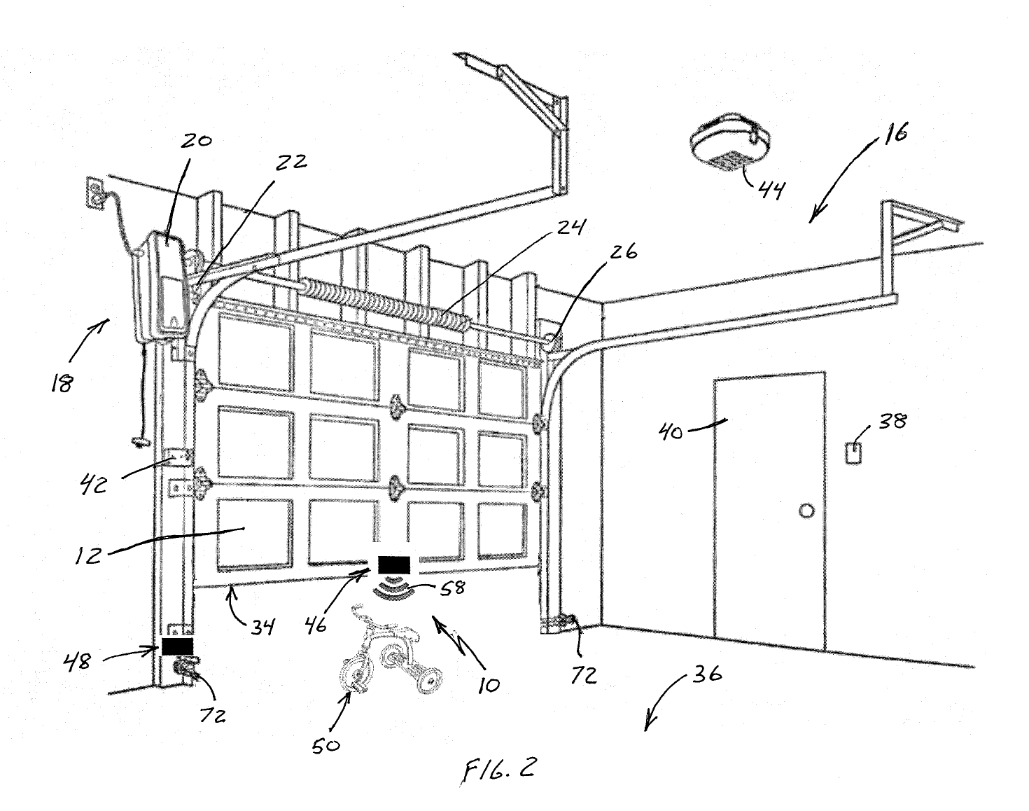

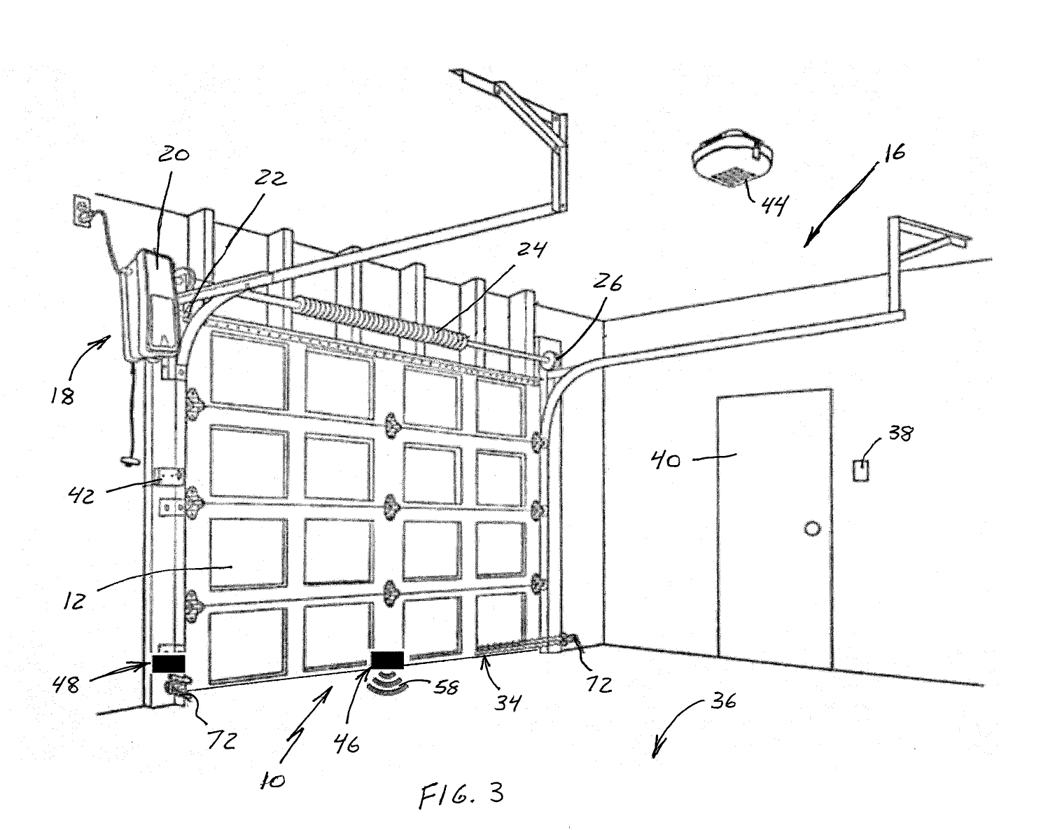

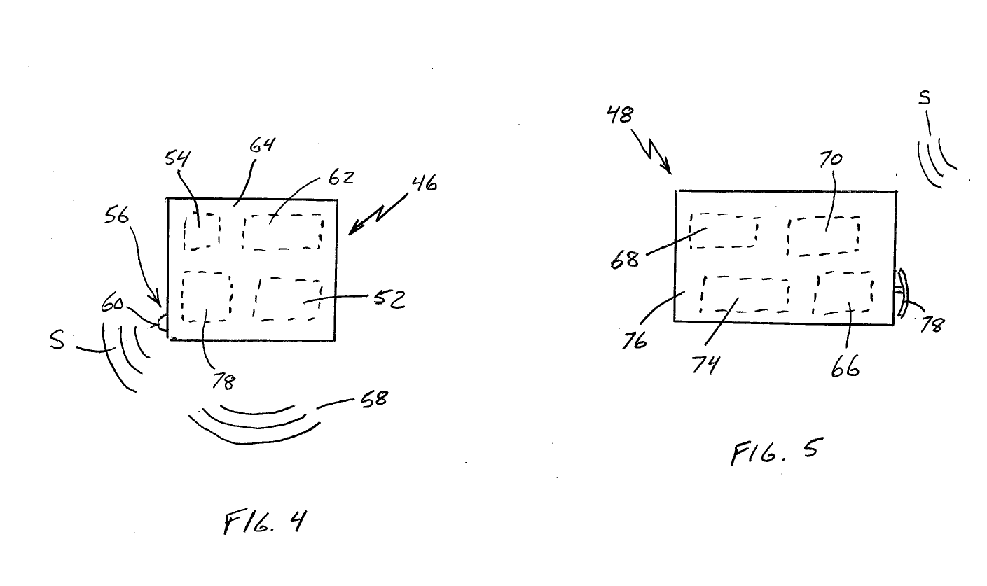

The object detection apparatus 10 of the present invention generally comprises a transmitter unit 46 and a receiver unit 48. The transmitter unit 46 is configured to determine the existence of an object, shown as 50 in FIG. 2, that is in the opening 14 along the path P of the garage door 12 as it moves downward from its open position, shown at or near in FIG. 1, to its closed position, shown near in FIG. 3. The transmitter unit 46 comprises a proximity sensor 52, a microprocessor 54, a tilt switch 55 and a transmission source 56, as shown in FIG. 4. Proximity sensor 52 is configured to transmit a proximity signal, shown as 58 in FIGS. 1 through 4, that is utilized to determine the presence of an object 50 in the path P of the garage door 12 as it moves downward toward the garage floor 36. The use and configuration of a proximity sensor 52 to determine the distance between two objects is generally well known (although not utilized in the present art) and can be utilized in the present invention to determine the proximity of the leading edge 34 of garage door 12 to the floor 36 of garage 16. The microprocessor 54 is configured to operatively control the operation of the apparatus 10 of the present invention, as set forth in more detail below. The tilt switch 55 is configured to determine whether the garage door 12 is in its upward position (e.g., in or near its open position) and is connected to microprocessor 54. The transmission source 56 is configured and positioned on the transmitter unit 46 to transmit a signal S to the receiver unit 48. In the embodiment shown in FIG. 4, the transmission source 56 is a LED 60 that emits light (as the signal S) in the general direction of the receiver unit 48. In an alternative embodiment of apparatus 10 of the present invention, the transmission source 56 can be configured to transmit an RF signal (as signal S), preferably a highly directional RF signal, towards receiver unit 48. The receiver unit 48 receives and processes the signal S, whether light or RF, from the transmitter unit 46. The transmitter unit 46 is connected to a source of power, such the battery 62 shown in FIG. 4, and the components thereof are operatively connected together and disposed inside or mounted onto a housing 64. In a preferred embodiment, the housing 64 of transmitter unit 46 is fixedly mounted at or near the leading edge 34 of the garage door 12, as shown in FIGS. 1 through 3.

As best shown in FIG. 5, in one embodiment receiver unit 48 has an appropriately configured source receiving device 66, a microprocessor 68 and a door reversing mechanism 70 that cooperated together to receive the signal from the transmission device 56 of transmitter unit 46 and stop and/or reverse the downward movement of the garage door 12 if an object 50 is in the path P of the garage door 12. In an alternative embodiment, microprocessor 68 is not utilized. The source receiving device 66 is configured to receive the light generated from LED 60 or the RF signal from the RF transmitter. In the embodiment having a microprocessor 68, the microprocessor 68 is configured to direct door reversing mechanism 70 to operate to stop the downward movement of the garage door 12 and, typically, reverse its direction. Door reversing mechanism 70 is configured to cooperatively engage, either electronically or mechanically, the standard safety reversing sensor 72, shown in FIGS. 1 through 3, that directs a beam of light across the opening 14 closed by the garage door 12 and which is provided with all garage door systems 18. The configuration and operation of the safety reversing sensor 72 is well known in the art. In one configuration, the door reversing mechanism 70 is electrically connected to the safety reversing sensor 72 and is configured to break the electrical circuit to the safety reversing sensor 72 to cause it to stop and/or reverse the direction of the garage door 12. In another configuration, the door reversing mechanism 70 comprises a flag-like object or other device that is moved into or out of a position between the pair of safety reversing mechanisms 72 to break the beam of light and cause the garage door 12 to stop moving downward and, typically, reverse direction.

The receiver unit 48 is connected to a source of power, such as from the battery 74 shown in FIG. 5 or from the same source of power utilized to power safety reversing sensor 72, and the components thereof are operatively connected together and are disposed inside or mounted onto a housing 76. In a preferred embodiment, the housing 76 of transmitter unit 46 is fixedly mounted near the sides 30/32 of garage door opening 14 at or near one of the safety reversing mechanisms 72, as shown in FIGS. 1 through 3. To prevent erroneous readings from the proximity sensor 52 reading the floor 36 of the garage 16, the receiver unit 48 also includes a shield 78, shown in FIG. 5, that is configured to block the signal S from the transmitter unit 46 when the leading edge 34 of the garage door 12 is at or near the floor 36. The size, position and angle of shield 78 should be selected so as to allow the receiver unit 48 to continue to receive signal S from transmitter unit 46 as close as possible to floor 36 without causing an erroneous reading of the floor 36 to be an object 50.

In use, the garage door 12 will move upward and downward to open or close the garage door opening 14 as normal unless an object 50 is in the path P of the downward movement of the garage door 12. The proximity sensor 52 of the transmitter unit 46 is always on and directing the proximity signal 58 outward from the leading edge 34 of the garage door 12. When the garage door 12 is at or near its open position, the tilt switch 55 breaks power from the battery 62 or other source of power to the transmitter unit 46, thereby deactivating the apparatus 10. When the garage door 12 is moving in a downwardly direction to its closed position, tilt switch 55 reconnects the power to the transmitter unit 46 and the proximity signal 58 from proximity sensor 52 is directed downward in the general direction of the floor 36 in garage door opening 14, which will be below the leading edge 34 of garage door 12, and begins taking readings below garage door 12. The proximity sensor 52 will determine if an object 50, which can be a person, vehicle or other item, is in the path P of the garage door 12. If an object 50 is detected, then the microprocessor 54 activates the transmission device 56 to immediately transmit a signal S towards the receiver unit 48. As set forth above, the signal S can be an light pulse from LED 60, a RF signal from an RF device or similar signals. The source receiving device 66 of the receiver unit 48 receives the signal S from the transmitter unit 46 and microprocessor 68 (if utilized with apparatus 10) operates the door reversing mechanism 70 to cause safety reversing mechanism 72 to stop and/or reverse the movement of the garage door 12. The shield 78 will prevent the source receiving device 66 of the receiver unit 48 from receiving signal S when the leading edge 34 of the garage door 12 is close to the floor 36. In a preferred embodiment, the microprocessor 54 of the transmitter unit 46 is configured to place the transmitter unit 46 in a sleep mode after sending out signal S so as to save power from the battery 62. The transmitter unit 46 can remain inactive until the tilt switch 55 has gone through one more cycle of opening and closing, corresponding to the garage door 12 becoming fully open and beginning to close again. The receiver unit 48 remains constantly on waiting for signal S from the transmitter unit 46. As stated above, the door reversing mechanism 70 of the receiver unit 48 can be configured to electronically, mechanically or otherwise break the light beam between the safety reversing mechanisms 72 so as to cause the garage door 12 to stop and/or reverse if an object 50 is detected. When utilized with a garage door 12, object detection apparatus 10 will prevent injury to persons or pets and damage to vehicles and other objects 50 in the downward path P of the garage door 12.

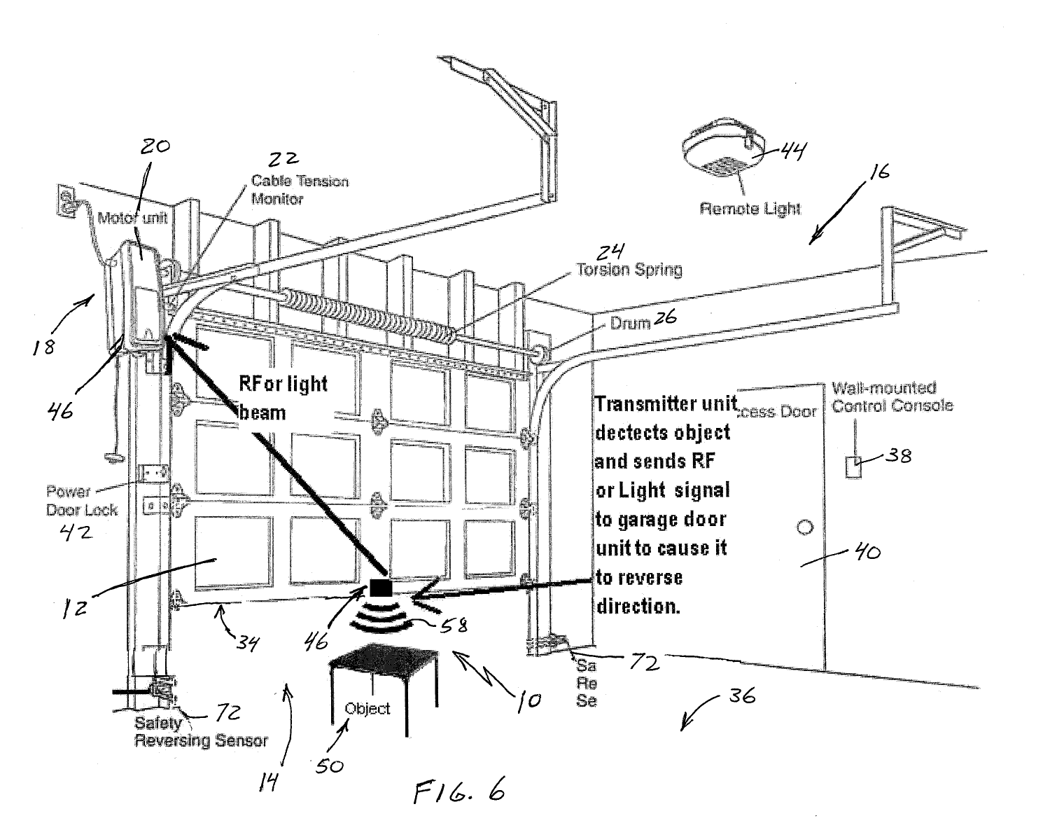

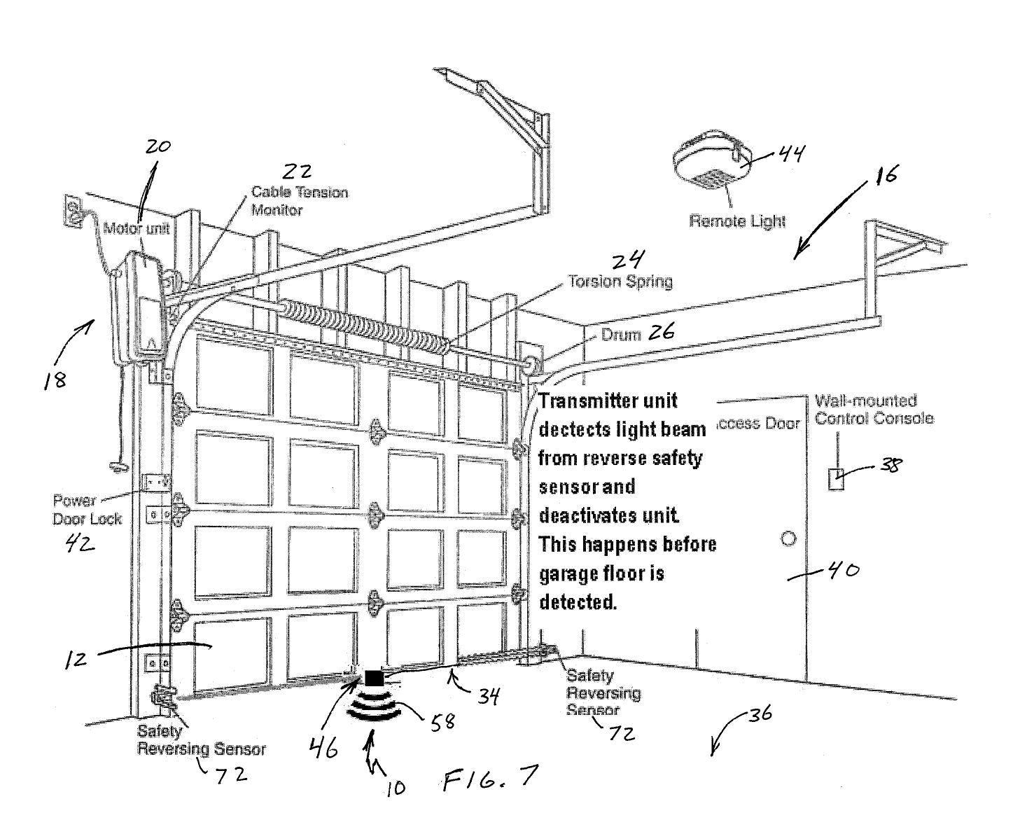

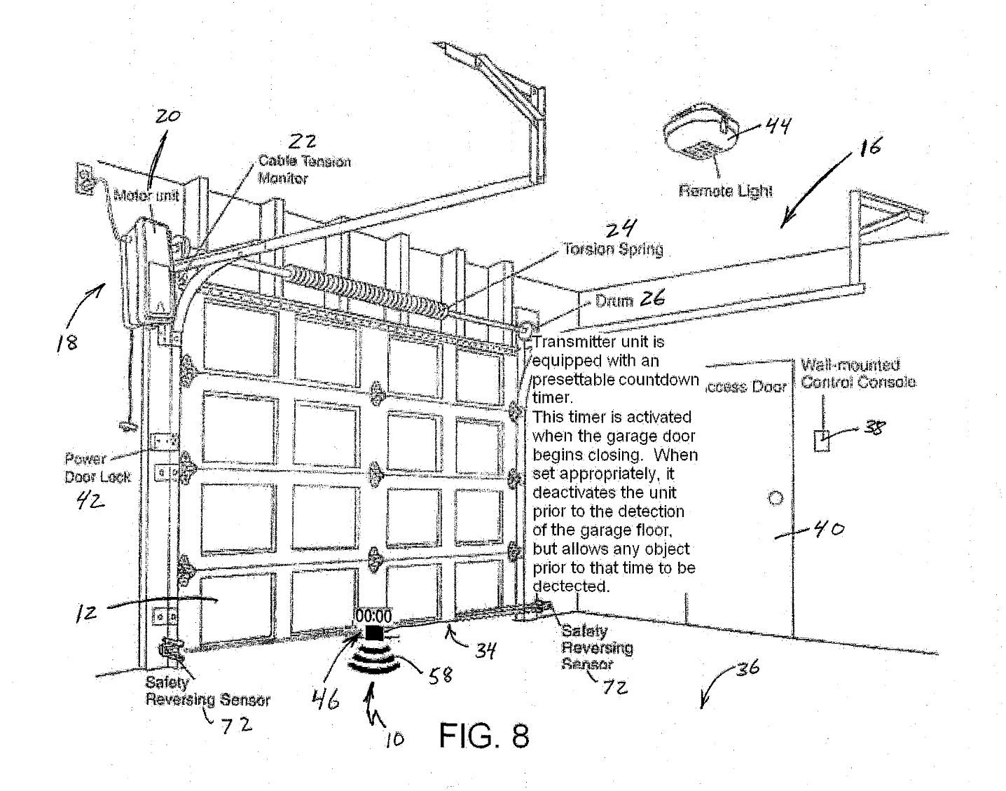

An alternative embodiment of the present apparatus 10 is shown in FIG. 6. In this embodiment, the transmitter unit 46 sends an RF or light signal to the garage door motor unit 20 when the transmitter unit 46 detects an object 50 in the path P of the garage door 12. The receiver unit 48 can be incorporated into, attached to or otherwise associated with the motor unit 20 to receive the signal S from the transmitter unit 46. A second alternative embodiment of the apparatus 10 of the present invention is shown in FIG. 7. In this embodiment, the transmitter unit 46 is configured to detect the light beam from the safety reversing mechanism 72 and deactivate the apparatus 10 before the transmitter unit 46 detects the floor 36 of the garage 16. A third alternative embodiment of the apparatus 10 of the present invention is shown in FIG. 8. In this embodiment, the transmitter unit 46 is operatively connected or comprises a presettable countdown timer that is activated when the garage door 12 begins its downward travel from its uppermost or open position. The timer is configured to deactivate the transmitter unit 46 when the time expires. Although the countdown timer deactivates the transmitter unit 46 prior to the detection of the garage floor 36, as described above, the apparatus is configured to still allow detection of any object 50 in the downward path P of the garage door 12 prior to the expiration of the time on the countdown timer.

While there are shown and described herein one or more specific embodiments of the present invention, it will be readily apparent to those skilled in the art that the invention is not so limited, but is susceptible to various changes in quantities and materials without departing from the spirit and scope of the invention. The foregoing descriptions of specific embodiments of the present invention have been presented for purposes of illustration and description and are not intended to be exhaustive or to limit the scope of the invention to the precise forms disclosed. The above embodiments were set forth above for the purposes of best illustrating and explaining the principles of the present invention and one or more practical uses thereof so as to enable persons skilled in the art to best understand and utilize the present invention. Persons skilled in the art will readily understand and appreciate that they will be able to utilize the teachings of this disclosure to modify the present invention as may be necessary to suit their specific needs and/or requirements without departing from the spirit or scope of the claims of the present invention.

What is claimed is:

1. An detection apparatus, comprising:
a transmitter unit attached to or otherwise associated with a retractable door to determine if an object is in a downward path of said retractable door, said transmitter unit having a proximity sensor directed downward from said retractable door when said retractable door is moving in a downward direction so as to determine if said object is in said downward path, a tilt switch structured and arranged to determine if said retractable door is moving in an upward direction, a transmission source configured to transmit a signal upon detection of said object in said downward path, a microprocessor operatively connected to each of said proximity sensor, said tilt switch and said transmission source and a source of power electrically connected to each of said proximity sensor, said tilt switch, said transmission source and said microprocessor, said microprocessor configured to operatively control operation of each of said proximity sensor, said tilt switch and said transmission source; and
a receiver unit in communication with said transmitter unit so as to receive and process said signal from said transmission source, said receiver unit having a source receiving device, a door reversing mechanism and a source of power that are operatively connected together so as to receive said signal from said transmission source and stop and/or reverse the downward movement of said retractable door to avoid making contact with said object, said source receiving device cooperatively configured with said transmission source so as to receive said signal transmitted from said transmission source, said door reversing mechanism connected to a safety reversing sensor associated with said retractable door so as to operatively engage said safety reversing sensor and stop the downward movement of said retractable door.

2. The detection apparatus of claim 1, wherein said transmitter unit is attached to a leading edge of said retractable door and said proximity sensor is directed generally downward from said leading edge.

3. The detection apparatus of claim 2, wherein said transmitter unit is disposed in a housing fixedly mounted at or near said leading edge of said retractable door.

4. The detection apparatus of claim 1, wherein said transmission source is a LED that emits a light signal in the direction of said receiver unit and said source receiving device is configured to receive said light signal.

5. The detection apparatus of claim 1, wherein said transmission source is configured to transmit an RF signal towards said receiver unit and said source receiving device is configured to receive said RF signal.

6. The detection apparatus of claim 5, wherein said RF signal is a highly directional RF signal.

7. The detection apparatus of claim 1, wherein said receiver unit further comprises a microprocessor configured to direct said door reversing mechanism so as to stop the downward movement of said retractable door.

8. The detection apparatus of claim 7, wherein said microprocessor is further configured to reverse the direction of said retractable door after stopping the downward movement thereof.

9. The detection apparatus of claim 1, wherein said receiver unit is disposed in a housing mounted.

10. The detection apparatus of claim 1, wherein said housing is mounted at or near said safety reversing sensor.

11. The detection apparatus of claim 1, wherein said receiver unit further comprises a shield configured to block said signal from said transmitter unit when a leading edge of said retractable door is at or near a floor to reduce the likelihood of erroneous readings from said proximity sensor.

12. The detection apparatus of claim 1, wherein said tilt switch is configured to deactivate the detection apparatus by breaking the connection between the transmitter unit and the source of power when said retractable door is at or near an open position and reactivate the detection apparatus by reconnecting the transmitter unit and the source of power when said retractable door is moving in the downward direction.

13. The detection apparatus of claim 1, wherein said transmitter unit further comprises a countdown timer that is activated when said retractable door begins its downward travel from an open position.
